(19) United States
(12) Patent Application Publication
(10) Pub. No.: US 2010/0254003 A1
(43) Pub. Date: Oct. 7, 2010

(54) Anti-Reflection Film

(75) Inventors: Eiichi Higashikawa, Tokyo (JP); Toshiaki Yoshihara, Tokyo (JP); Koichi Ohata, Tokyo (JP)

Correspondence Address: SQUIRE, SANDERS & DEMPSEY L.L.P., 275 BATTERY STREET, SUITE 2600, SAN FRANCISCO, CA, 94111-3356, US

(73) Assignee: Toppan Printing Co., Ltd., Tokyo (JP)

(21) Appl. No.: 12/817,837

(22) Filed: Jun. 17, 2010

Related U.S. Application Data
(63) Continuation of application No. PCT/JP2008/072548, filed on Dec. 11, 2008.

(30) Foreign Application Priority Data
Dec. 20, 2007 (JP) 2007-328569

(51) Int. Cl. G02F 1/1335; G02B 1/11; G02B 5/30

(52) U.S. Cl. 359/493; 359/580; 349/96

(57) ABSTRACT

The present invention provides an anti-reflection film which not only has a sufficient anti-reflection properties and sufficient antistatic properties but also reduces color in reflection light, inhibits color unevenness and provides a display device with excellent contrast in a bright place and excellent contrast in a dark place when applied on a display device. The anti-reflection film of the present invention has average luminous reflectance in the range of 0.5-1.5% on a low refractive index layer surface, a difference in the range of 0.2-0.9% between the maximum and the minimum in spectral reflectance on the low refractive index layer surface in a wavelength region of 400-700 nm, absorption loss in average luminous transmittance in the range of 0.5-3.0%, and parallel light transmittance in the range of 94.0-96.5%.

This application is a continuation of International Application No. PCT/JP2008/072548, filed Dec. 11, 2008, which is incorporated herein by reference in its entirety.

### BACKGROUND OF THE INVENTION

1. Field of the Invention

The present invention relates to an anti-reflection film which is arranged in order to prevent external light from reflecting on a window or a surface of display devices etc. Specifically, the present invention relates to an anti-reflection film applied on a surface of a liquid crystal display (LCD), CRT display, organic electroluminescent display (ELD), plasma display (PDP), surface-conduction electron-emitter display (SED) and field emission display (FED) etc. Among these, this invention relates to an anti-reflection film applied on a surface of a liquid crystal display (LCD).

2. Description of the Related Art

In general, displays are used under external light whether they are used indoors or outdoors. The external light incident to a display surface is reflected on the surface so that a displayed image is interfered with by the reflected image and the quality of display decreases. Hence, it is necessary to provide a display surface with an anti-reflection function, and further, improvements of the anti-reflection function along with introductions of other extra useful functions are being demanded.

In general, an anti-reflection function is realized by forming an anti-reflection layer having a multilayer structure repeating high refractive index layers and low refractive index layers made of a transparent material such as metal oxide on a transparent substrate. The anti-reflection layer having this type of multilayer structure can be obtained by a dry coating method such as chemical vapor deposition (CVD) and physical vapor deposition (PVD). In the case where the anti-reflection layer is formed by dry coating, while there is an advantage of fine thickness controllability, there is also a problem of low productivity due to a limitation of the deposition process performed in a vacuum chamber, which is unsuitable for mass production. Thus, wet coating methods, which make it possible to provide a large display and continuous production, and reduce costs, attract attention as a forming method of an anti-reflection layer

In addition, an anti-reflection film in which the anti-reflection layer is arranged on a transparent substrate generally has a hard coat layer made of an acrylic polyfunctional polymer between the transparent substrate and the anti-reflection layer for the purpose of providing a surface hardness to a relatively soft surface of the anti-reflection layer. The hard coat layer is provided with a high level of surface hardness, luster, transparency, and abrasion resistance due to the acrylic resin. However, the hard coat layer is liable to take charge because of its insulation properties and has problems of dust collecting on the surface of the anti-reflection film in which the hard coat layer is arranged and damaging a product device by an electric charge in a manufacturing process of a display device.

In order to provide an antistatic function to an anti-reflection film, a method of adding conductive agent to the hard coat layer or a method in which an antistatic layer is arranged between the substrate and the hard coat layer or between the hard coat layer and the anti-reflection layer can be used.

<Patent document 1>: JP-A-2005-202389.

<Patent document 2>: JP-A-2005-199707.

<Patent document 3>: JP-A-2006-016447.

Whereas there is a problem of an increase of material costs and a decrease in hardness in the method of adding a conductive agent to the hard coat layer because it is necessary to add a large amount of conductive agent to obtain high conductivity, there is a problem of colored appearance and/or uneven coloring in the method in which an antistatic layer is newly arranged between the substrate and the hard coat layer or between the hard coat layer and the anti-reflection layer because it is necessary in general to dispose an antistatic layer with a high refractive index between the substrate and the hard coat layer or between the hard coat layer and the anti-reflection layer etc. Particularly when the anti-reflection layer and/or the low refractive index layer are formed by a wet coating method, a problem such as uneven colored appearance of an anti-reflection film occurs according to in-plane thickness non-uniformity of the antistatic layer and/or the low refractive index layer.

In addition, in the case where the anti-reflection film is provided with antistatic properties by adding a conductive agent to the antistatic layer, optical characteristics of the anti-reflection film varies depending on a type of the added conductive agent.

If the anti-reflection film having the hard coat layer, antistatic layer and the anti-reflection layer is applied on a surface of a display device, anti-reflection properties of the anti-reflection film make it possible to suppress reflection of external light so as to improve the contrast of the display device in a bright place. In addition, it becomes possible to display an image brighter since the transmittance is improved. Moreover, as an output power of the backlight is reduced, an energy saving effect can also be expected.

In the case of the anti-reflection film added with the conductive agent, however, there is problem that only insufficient contrast is achieved due to a decrease of luminance in displaying a white image (This type of luminance may also be referred to as “white luminance” hereinafter.) because transmittance of the anti-reflection film falls by an addition of the conductive agent.

In transmission type LCDs, there is also a problem of low contrast in a dark place due to insufficiently low luminance in displaying a black image (This type of luminance may also be referred to as “black luminance” hereinafter.) because it is difficult to make the orthogonal transmittance of the polarizing plate zero and so-called “light leakage” occurs. A transmission type LCD which has an anti-reflection film on the surface is particularly provided with improved transmittance and external light reflection preventing properties. This improvement in transmittance by providing the anti-reflection function, however, causes an increase of light leakage in displaying a black image and brings about a problem of high black luminance and low contrast in a particularly dark place.

### SUMMARY OF THE INVENTION

It is an objective of the present invention to provide an anti-reflection film having a hard coat layer, an antistatic layer which is added with a conductive agent and a low refractive index layer in order on a transparent substrate, and having not only sufficient anti-reflection properties and sufficient antistatic properties but also excellent contrast in a bright place and excellent contrast in a dark place when applied on a surface of a transmission type LCD in particular.

In order to solve the problems described above, a first aspect of the present invention is an anti-reflection film including a transparent substrate, a hard coat layer, an antistatic layer and a low refractive layer, the hard coat layer, the antistatic layer and the low refractive index layer being formed on the transparent substrate, average luminous reflectance of the anti-reflection film on the low refractive index layer's surface being in the range of 0.5-1.5%, a difference between the maximum and the minimum in spectral reflectance of the anti-reflection film on the low refractive index layer's surface within a wavelength region in the range of 400-700 nm being in the range of 0.2-0.9%, an absorption loss in average luminous transmittance of the anti-reflection film being in the range of 0.5-3.0%, and a parallel light transmittance of the anti-reflection film being in the range of 94.0-96.5%.

In addition, a second aspect of the present invention is the anti-reflection film according to the first aspect of the present invention, wherein a difference between the maximum of absorption loss in light transmittance of the anti-reflection film at wavelengths in the range of 400-700 nm and the minimum of absorption loss in light transmittance of the anti-reflection film at wavelengths in the visible light region is 4.0% or less.

In addition, a third aspect of the present invention is the anti-reflection film according to the first or second aspect of the present invention, wherein a haze of the anti-reflection film is 0.5% or less.

In addition, a fourth aspect of the present invention is the anti-reflection film according to any one of the first to third aspects of the present invention, wherein a difference between the maximum of absorption loss in light transmittance of the anti-reflection film at wavelengths in the visible light region and the minimum of absorption loss in light transmittance of the anti-reflection film at wavelengths in the visible light region is in the range of 0.5-4M %, and absorption losses in light transmittance of the anti-reflection film at wavelengths of 450 nm, 550 nm and 650 nm satisfies Q₄₅₀<Q₅₅₀<Q₆₅₀, wherein Q₄₅₀ is the absorption loss in light transmittance at a wavelength of 450 nm, Q₅₅₀ is the absorption loss in light transmittance at a wavelength of 550 nm and Q₆₅₀ is the absorption loss in light transmittance at a wavelength of 650 nm.

In addition, a fifth aspect of the present invention is the anti-reflection film according to any one of the first to fourth aspects of the present invention, wherein the antistatic layer includes an electron conducting polymer and/or electron conducting inorganic particles.

In addition, a sixth aspect of the present invention is the anti-reflection film according to any one of the first to fifth aspects of the present invention, wherein the antistatic layer includes at least any one of ATO (antimony doped tin oxide), PTO (phosphor doped tin oxide), FTO (fluorine doped tin oxide) and ITO (indium oxide tin oxide).

In addition, a seventh aspect of the present invention is the anti-reflection film according to any one of the first to sixth aspects of the present invention, wherein surface resistivity of the anti-reflection film on a surface of the low refractive index layer is in the range of 1.0×10⁶Ω/□ to 1.0×10¹¹Ω/□.

In addition, an eighth aspect of the present invention is the anti-reflection film according to any one of the first to seventh aspects of the present invention, wherein reflection hue in the L*a*b* coordinate system on a surface of the low refractive index layer of the anti-reflection film satisfies 0.00≦a*≦3.00 and −3.00≦b*≦3.00.

In addition, a ninth aspect of the present invention is the anti-reflection film according to any one of the first to eighth aspects of the present invention, wherein a difference in refractive index of the hard coat layer and the transparent substrate is 0.05 or less.

In addition, a tenth aspect of the present invention is a polarizing plate including the anti-reflection film according to any one of the first to ninth aspects of the present invention, a polarizing layer and a second transparent substrate, wherein said transparent substrate of said anti-reflection film has a first surface and a second surface opposite the first surface, said low refractive index layer is disposed on the first surface, and the polarizing layer and the second transparent substrate are arranged on the second surface.

In addition, an eleventh aspect of the present invention is a transmission type LCD device including the anti-reflection film according to tenth aspect of the present invention, a liquid crystal cell, a second polarizing plate and a backlight unit.

By making an anti-reflection film of a structure described above, it is possible to obtain an anti-reflection film having not only sufficient anti-reflection properties and sufficient antistatic properties but also suppressed colored-appearance, reduced color unevenness, and excellent contrast in a bright place and excellent contrast in a dark place when the film is applied on a display device surface, particularly, a transmission type LCD.

### BRIEF DESCRIPTION OF THE DRAWINGS

FIG. 1 is a cross section exemplary diagram of an anti-reflection film of the present invention.

FIG. 2 is a cross section exemplary diagram of a polarizing plate using an anti-reflection film of the present invention.

FIG. 3 is a cross section exemplary diagram of a transmission type LCD device having an anti-reflection film of the present invention.

FIG. 4 is a spectral reflectance curve of an anti-reflection film obtained in <<Example 1>>.

FIG. 5 is a spectral reflectance curve of an anti-reflection film obtained in <<Example 2>>.

FIG. 6 is a spectral reflectance curve of an anti-reflection film obtained in <<Comparative example 3>>.

FIG. 7 is a spectral reflectance curve of an anti-reflection film obtained in <<Comparative example 4>>.

### DESCRIPTION OF REFERENCE NUMERALS

1: Anti-reflection film.
11: Transparent substrate.
12: Hard coat layer.
13: Antistatic layer.
14: Low refractive index layer.
2: Polarizing plate.
22: Transparent substrate.
23: Polarizing layer.
3: Liquid crystal cell.
4: Polarizing plate.
41: Transparent substrate.
42: Transparent substrate.
43: Polarizing layer.
5: Backlight unit.

### DESCRIPTION OF PREFERRED EMBODIMENTS

An anti-reflection film of the present invention is described below.

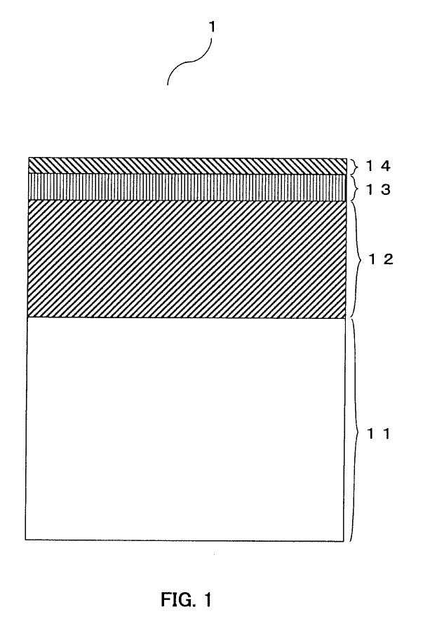

FIG. 1 shows a cross section exemplary diagram of an anti-reflection film of the present invention. The anti-reflection film (1) illustrated in FIG. 1 has a hard coat layer (12), an antistatic layer (13) and a low refractive index layer (14) in order on a transparent substrate (11). In addition, the antistatic layer (13) includes conductive particles (13A) and a binder matrix (13B), and the low refractive index layer (14) includes low refractive index particles (14A) and a binder matrix (14B).

An anti-reflection function is derived from an optical interference between the low refractive index layer (14) and an antistatic layer (13) in the anti-reflection film of the present invention. In other words, the antistatic layer (13) works as a high refractive index layer. It is possible to prevent reflection of external light incident to a surface of an anti-reflection film and improve contrast in a bright place by arranging a low refractive index layer and the antistatic layer which acts as a high refractive index layer on a transparent substrate. Moreover, it is possible to improve white luminance and contrast in displaying a white image.

A coating liquid for forming an antistatic layer which contains a conductive material is used in forming an antistatic layer (13) of an anti-reflection film of the present invention. The antistatic layer is formed by coating the coating liquid for forming the antistatic layer on a hard coat layer by a wet coating method. Similarly, a coating liquid for forming a low refractive index layer is used in forming a low refractive index layer (14), and the low refractive index layer is formed by coating the coating liquid for forming the low refractive index layer by the wet coating method. It is possible to manufacture the anti-reflection film at a lower cost by employing a wet coating method than in the case where a dry coating method, which requires vacuum deposition equipment, is employed.

It is a feature of the anti-reflection film of the present invention that average luminous reflectance of the film on a surface of the low refractive index layer side is in the range of 0.5-1.5%, a difference between the maximum and the minimum in spectral reflectance of the film in the wavelength region of 400-700 nm is in the range of 0.2-0.9%, absorption loss in average luminous transmittance of the film is in the range of 0.5-3.0%, and parallel light transmittance of the film is in the range of 94.0-96.5%.

It is a feature of the anti-reflection film of the present invention that average luminous reflectance of the film on a surface of the low refractive index layer side is in the range of 0.5-1.5%. If the average luminous reflectance of the film is higher than 1.5%, it is impossible to provide the film with a sufficient anti-reflection function suitable for applying on a surface of a display device whereas if the average luminous reflectance is less than 0.5%, it becomes difficult to make the difference between the maximum and the minimum of spectral reflectance of the film in the wavelength region of 400-700 nm 0.9% or less as described later.

It is a feature of the anti-reflection film of the present invention that a difference (A−B) between the maximum (A) in spectral reflectance and the minimum (B) in spectral reflectance of the film in the wavelength region of 400-700 nm is in the range of 0.2-0.9%. When the difference (A−B) between the maximum (A) and the minimum (B) in spectral reflectance of the film in the wavelength region of 400-700 nm is in the range of 0.2-0.9%, the spectral reflectance curve moderately increases as wavelength increases. If the shape of the spectral reflectance curve is significantly gentle, it is possible to make the anti-reflection film having not only an almost colorless reflection hue but also no color unevenness.

In the case where the antistatic layer and the low refractive index layer are formed by a wet coating method using coating liquids, the production cost can be dramatically reduced relative to the case where the antistatic layer and the low refractive index layer are formed be a dry coating method, in which vacuum equipment is required. It is possible to provide an anti-reflection film at a low cost if the antistatic layer and the low refractive index layer are formed by a wet coating method.

However, in-plane thickness of the antistatic layer and/or in-plane thickness of the anti-reflection layer are more liable to vary to a small extent in the case where the antistatic layer and the anti-reflection layer are formed by a wet coating method, in which a coating liquid is used, than in the case where the antistatic layer and/or the anti-reflection layer are formed by a dry coating method such as a deposition method and sputtering method. A small variation in in-plane thickness of the antistatic layer and/or the anti-reflection layer is observed as in-plane color unevenness because an anti-reflection function of the anti-reflection film is provided by optical interference between the antistatic layer and the anti-reflection layer.

In the present invention, it is possible to prevent color unevenness caused by a small variation in thickness of the anti-reflection layer and/or the antistatic layer by making a spectral reflectance curve of the anti-reflection film a significantly gentle curve. In other words, it is possible to make the anti-reflection film of the present invention a film on which color unevenness is hardly observed even when a small variation in in-plane thickness of the antistatic layer and/or the anti-reflection layer occur by a wet coating method. In the case where the variations in reflectance with respect to wavelength are large according to the spectral reflectance curve, color unevenness is easily recognized because the color tone of the film tends to vary when the spectral reflectance varies due to variations in thickness of the antistatic layer and the low refractive index layer.

In the case where a difference (A−B) between the maximum (A) and the minimum (B) of spectral reflectance of the anti-reflection film on a surface of the low refractive index layer side exceeds 0.9% in the wavelength region of 400-700 nm, the spectral reflectance curve of the film accordingly has a sharp curve. Then, not only does the reflection hue become large but the color unevenness caused by thickness variations of the antistatic layer and/or the anti-reflection layer is also observed.

In addition, it is preferable that a difference (A−B) between the maximum (A) and the minimum (B) of the spectral reflectance of the anti-reflection film surface on the low refractive index layer side in the wavelength region in the range of 400-700 nm is small. It is, however, difficult to make an anti-reflection film having a value less than 0.2% of a difference (A−B) between the maximum (A) and the minimum (B) of the spectral reflectance by an optical interference of two layers, namely, the low refractive index layer and the antistatic layer.

In the present invention, it is possible to make the spectral reflectance curve quite a gentle curve in the wavelength region of 400-700 nm by making the spectral reflectance curve have one local minimal value in the wavelength region of 400-700 nm and making a difference (A−B) between the maximum (A) and the minimum (B) of the spectral reflectance of the anti-reflection film surface on the low refractive index layer side in the wavelength region of 400-700 nm 0.9% or less.

In the anti-reflection film of the present invention, the maximum (A) of the spectral reflectance of the anti-reflection film on the low refractive index layer side in the wavelength region of 400-700 nm is the reflectance at a wavelength of 400 nm whereas the minimum (B) of the same is a reflectance at a wavelength in the range of 450-600 nm.

An anti-reflection film having an average luminous reflectance in the range of 0.5-1.5% and a value in the range of 0.2-0.9% as a difference between the maximum and the minimum of the spectral reflectance on the surface of the low refractive index layer side in the wavelength region of 400-700 nm has a spectral reflectance curve which moderately declines as a wavelength increases and alters to moderately increase once it turns a certain point in the 450-600 nm region so that a U-shaped curve is formed and the curve is almost flat in a wavelength region close to 550 nm where relative luminous efficiency is high. In this way, it is possible not only to make the reflection hue of the anti-reflection film almost colorless but also prevent color unevenness from occurring.

In order to obtain an anti-reflection film having a colorless reflection hue and no color unevenness, it is necessary to make the spectral reflectance curve as flat as possible in the wavelength region close to 550 nm where the relative luminous efficiency is high. In the anti-reflection film in the present invention, it is possible to make the amount of reflectance change small in the declining part of the spectral reflectance curve within the low wavelength region (around 400-450 nm) and in the increasing part of the spectral reflectance curve within the high wavelength region (around 600-700 nm) by making a difference (A−B) between the maximum (A) and the minimum (B) of spectral reflectance in the wavelength region of 400-700 nm a value in the range of 0.2-0.9%. In particular, it is possible to reduce the amount of reflectance change in the declining part of the spectral reflectance curve within the low wavelength region (around 400-450 nm) and make the anti-reflection film have an almost colorless reflection hue and no blue color unevenness.

The lower the average luminous reflectance of the anti-reflection film is, the higher the anti-reflection performance of the anti-reflection film becomes. In the case where the average luminous reflectance is made excessively low, however, it is difficult to reduce the color of reflection light and prevent color unevenness from occurring. In the present invention, the inventor succeeded in reducing the color of reflection light and preventing color unevenness occurring by adjusting the average luminous reflectance within the range of 0.5-1.5% and the spectral reflectance within the range of 0.2-0.9%. In other words, the inventor succeeded in reducing the color of reflection light and preventing color unevenness occurring caused by minor thickness variations of the low refractive index layer and/or the antistatic layer by making the spectral reflection curve of the low refractive index layer side a flat and gentle curve in the wavelength region of 400-700 nm.

In the present invention, the spectral reflectance curve of the anti-reflection film surface of the low refractive index layer side is measured by a spectral photometer after matte-black paint is coated on the opposite surface of the transparent substrate from the side on which the hard coat layer, the antistatic layer and the low refractive index layer are disposed. The spectral reflectance curve of the anti-reflection film is measured at an incident angle of 5 degrees from the vertical direction to the anti-reflection film surface using the c light source as a light source with a condition of two degrees of field of view. The average luminous reflectance is reflectance values at various wavelengths in the visible light region which are corrected using relative luminosity and averaged. At this time, a photopic relative luminous efficiency is used as the relative luminosity.

In addition, it it's a feature of the anti-reflection film of the present invention that the absorption loss in average luminous transmittance is in the range of 0.5-3.0%.

The absorption loss in average luminous transmittance is obtained by the formula (Formula 1) below.

Q=100−H−T−R: (Formula 1)

Q: Absorption loss in average luminous transmittance [%]

### H: Haze [%]

### T: Transmittance [%]

R: Reflectance on two (rear and front) surfaces [%]

The reflectance on two sides herein means a sum of the reflectance on the front surface Rs and the reflectance on the rear surface Rb. In measuring reflectance of the anti-reflection film of the present invention, the reflectance on the rear surface is cancelled by making it rough with sand paper etc. and coating black paint etc. and only the reflectance on the front surface is measured. At this point, if the reflectance on the rear surface is not cancelled when measuring spectral reflectance, it is possible to measure the reflectance on two surfaces R(Rs+Rb). As is apparent from (Formula 1), the absorption loss in transmittance in the present invention is not a loss caused by scattering but a loss caused by photoabsorption.

The haze (H) of the anti-reflection film can be obtained by JIS K 7105 (1981). The transmittance and reflectance on two surfaces of the anti-reflection film can be obtained by measuring spectral reflectance in a specular direction and in a straight forward direction at an incident angle of 5 degrees from the vertical direction to the anti-reflection film surface using the c light source as a light source with a condition of two degrees of field of view. The absorption loss in average luminous transmittance is absorption losses in transmittance at various wavelengths in the visible light region which are corrected using relative luminosity and averaged. At this time, a photopic relative luminous efficiency is used as the relative luminosity.

It is possible to produce an anti-reflection film having excellent contrast in a bright place and excellent contrast in a dark place by making the absorption loss in average luminous transmittance a value in the range of 0.5-3.0% in the anti-reflection film of the present invention. In the case where the absorption loss in average luminous transmittance of the anti-reflection film is less than 0.5%, it is impossible to sufficiently prevent light leakage when showing a black image, which means high black luminance and low contrast in a dark place. In contrast, in the case where the absorption loss in average luminous transmittance exceeds 3.0%, luminance when a white image is shown (white luminance) declines, and thus, the contrast declines although it is possible to suppress the black luminance.

In addition, it is also a feature of the present invention that the parallel light transmittance of the anti-reflection film of the present invention is in the range of 94.0-96.5%. It is possible to fix the contrast of the film to a good value by making the parallel light transmittance in the range of 94.0-96.5%. In the case where the parallel light transmittance of the anti-reflection film is less than 94.0%, the white luminance, which is a luminance while showing white image, decreases so that the contrast decreases. In the case where the parallel light transmittance of the anti-reflection film is less than 94.0%, an advantage of an improvement in parallel light transmittance provided by arranging a low refractive index layer is cancelled. On the other hand, it is practically difficult to manufacture an anti-reflection film having a parallel light transmittance more than 96.5% considering reflectance on the rear surface. Hence an anti-reflection film of the preset invention has a parallel light transmittance of 96.5% or less. The parallel light transmittance can be obtained according to JIS (Japanese Industrial Standards) K 7105 (1981).

In addition, it is preferable in the anti-reflection film of the present invention that a difference between the maximum and the minimum in absorption loss in light transmittance at various wavelengths in the visible light region is within 4.0%.

It is possible to provide the anti-reflection film for a display device application with a good color reproducibility by setting the difference between the maximum and the minimum of absorption loss in light transmittance at various wavelengths in the visible light region within 4.0so as to make a curve of the absorption loss in light transmittance have no acute peak in the entire range of the visible light and moderate dependence on the wavelength. In the case where the difference between the maximum and the minimum of absorption loss in light transmittance at various wavelengths in the visible light region exceeds 4.0%, a strong optical absorption appears in the visible light region resulting in a colored image when showing a white image. The visible light region, which is within the scope of a target determining the maximum and the minimum of the absorption loss in light transmittance in the present invention, refers to a wavelength region in the range of 400-700 nm.

In addition, it is preferable in the present invention that a difference between the maximum and the minimum of absorption loss in light transmittance at various wavelengths in the visible light region is within the range of 0.5-4.0%, and absorption losses in light transmittance at wavelengths of 450 nm, 550 nm and 650 nm, respectively, satisfy a relation of Q₄₅₀<Q₅₅₀<Q₆₅₀ (Q₄₅₀: the absorption loss in light transmittance at a wavelength of 450 nm, Q₅₅₀: the absorption loss in light transmittance at a wavelength of 550 nm and Q₆₅₀: the absorption loss in light transmittance at a wavelength of 650 nm).

It is possible to make the absorption loss in light transmittance in the visible light region gradually increase as the wavelength increases by making the difference between the maximum and the minimum of the absorption loss in light transmittance at various wavelengths in the visible light region in the range of 0.5-4.0% and the absorption losses in light transmittance satisfy the relation of Q₄₅₀<Q₅₅₀<Q₆₅₀ so that an anti-reflection film with an excellent color reproducibility when applied on a transmission type LCD surface can be obtained.

When a pair of polarizing plates in which an iodine-added elongated polyvinyl alcohol is used as the polarizing layer is arranged in such a way that the polarizing direction thereof becomes parallel to each other, a parallel transmission spectrum shows a transmittance curve which is low in the short wavelength region and high in the long wavelength region. Thus, transmission type LCD devices on which a polarizing plate having an iodine-added elongated polyvinyl alcohol as a polarizing layer used to be often colored somewhat yellow when showing a white image. If the anti-reflection film applied on the LCD surface has the difference between the maximum and the minimum of the absorption loss in light transmittance at various wavelengths in the visible light region in the range of 1.5-4.0% and absorption losses in light transmittance at various wavelengths satisfying a relation of Q₄₅₀<Q₅₅₀<Q₆₅₀, the absorption loss in light transmittance curve adopts a moderate absorption peak in the long wavelength region of the visible light region so that the anti-reflection film compensates the yellow color. In other words, spectral transmission properties can be neutralized and the yellow colored appearance of the transmission type LCDs when showing a white image can be prevented by combining the anti-reflection layer and a pair of the polarizing plates.

In the case where the difference between the maximum and the minimum of absorption loss in light transmittance at various wavelengths in the visible light region (wavelength in the range of 400-700 nm) exceeds 4.0%, a certain color in the visible region is observed due to the presence of a wavelength at which a specific strong optical absorption occurs.

In addition, it is preferable in the anti-reflection film of the present invention that a haze is 0.5% or lower. It becomes possible to provide the anti-reflection film of the present invention with higher contrast in a bright place by making the haze 0.5 or lower. In the case where the haze exceeds 0.5%, a black image is whitely blurred by scattering when displaying a black image in a bright place so that contrast is decreased although it is possible to pretend that light leakage when displaying a black image in a dark place is prevented due to a transmission loss by scattering. The haze of the anti-reflection film can be obtained according to JIS K 7105 (1981).

In addition, it is preferable in the anti-reflection film of the present invention that the antistatic layer contains an electron conducting polymer or electron conducting inorganic particles. It is necessary to add a conductive material in order to provide antistatic properties to the antistatic layer. At this time, the conductive material is divided into an electron conducting material and an ion conducting material. The electron conducting material has a more stable antistatic function even under a low humidity condition.

In addition, it is preferable in the present invention that the antistatic layer contains either antimony doped tin oxide (ATO), phosphor doped tin oxide (PTO) or fluorine doped tin oxide (FTO). Conductive particles of tin oxide series such as antimony doped tin oxide (ATO), phosphor doped tin oxide (PTO) and fluorine doped tin oxide (FTO) have a tendency that absorption loss in light transmittance at various wavelengths in the visible light region gradually increases as the wavelength becomes long. Thus, it is possible to gradually increase absorption loss in light transmittance at various wavelengths in the visible light region as the wavelength becomes long, and is possible to easily manufacture an anti-reflection film satisfying the relation of Q₄₅₀<Q₅₅₀<Q₆₅₀.

In addition, it is preferable in the present invention that surface resistivity on the low refractive index layer surface of the anti-reflection film is in the range of 1.0×10⁶Ω/□ to 1.0×10¹¹Ω/□. It is possible to provide the anti-reflection film with excellent antistatic properties by setting the surface resistivity on the low refractive index layer surface of the anti-reflection film within the range of 1.0×10⁶Ω/□ to 1.0×10¹¹Ω/□.

In the case where the surface resistivity of the anti-reflection film surface exceeds 1.0×10¹¹Ω/□, dust may stick to the anti-reflection film when the film is applied on a display surface because of its insufficient antistatic properties. In addition, charges on the display surface may also adversely affect interior operation and/or inner structure. In the case where the surface resistivity of the anti-reflection film on the low refractive index layer side is less than 1.0×10⁶Ω/□, it is necessary to add a large amount of conductive particles in the binder matrix, which is uneconomical. In addition, it may be impossible to adjust the optical properties of the film within the scope of the present invention.

In addition, it is preferable that the anti-reflection film of the present invention has a reflection hue of 0.00≦a*≦3.00 and −3.00≦b*≦3.00 in the L*a*b* coordination system on the surface of the low refractive index layer side of the anti-reflection film. It becomes possible to make the anti-reflection film colorless and obtain a more desirable anti-reflection film by adjusting the anti-reflection hue in the above described range.

The closer the a* and b* are, the more colorless the reflection hue is. The case of −3.00≦a*≦0.00, however, corresponds to a green region, in which the relative luminosity is high and a color tends to appear vivid to human vision. Therefore, it is preferable that the anti-reflection film of the present invention satisfies 0.00≦a*≦3.00 and −3.00≦b*≦3.00.

It is preferable in the anti-reflection film of the present invention that the difference in refractive index between the transparent substrate and the hard coat layer is 0.05 or less. In the case where the difference in refractive index between the transparent substrate and the hard coat layer exceeds 0.05, an interference fringe is generated by an optical interference between the transparent substrate and the hard coat layer. Due to the optical interference between the transparent substrate and the hard coat layer, it also becomes difficult to make the difference between the maximum and the minimum of the spectral reflectance in the wavelength region of 400-700 nm a value in the range of 0.2-0.9%.

The reflection hue of the anti-reflection of the present invention is measured by a spectral photometer after coating a matte-black paint on the opposite surface of the transparent substrate from the side on which the hard coat layer and the low refractive index layer are arranged. Using the C light source as the light source and setting both an incident angle of the light source and an output angle of the detector to 5 degrees, a spectral reflectance in the specular direction is measured under a condition of 2 degrees of field of view.

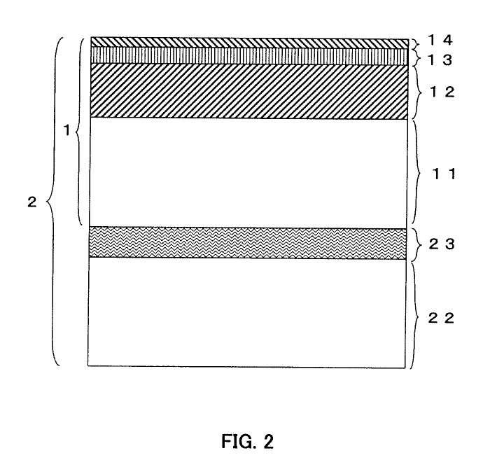

Next, a polarizing plate in which an anti-reflection film of the present invention is used is described. FIG. 2 illustrates a cross sectional exemplary diagram of a polarizing plate having an anti-reflection film of the present invention. A polarizing layer is interposed between two transparent substrates in the polarizing plate 2 of the present invention. The polarizing plate 2 of the present invention has the polarizing layer 23 and a transparent substrate 22 in order on the opposite surface of the transparent substrate 11 of the anti-reflection film 1 from the side on which the low refractive index layer 13 is arranged. In other words, the transparent substrate 11 of the anti-reflection film 1 of the present invention also plays the role of one of the transparent substrates between which the polarizing layer is interposed.

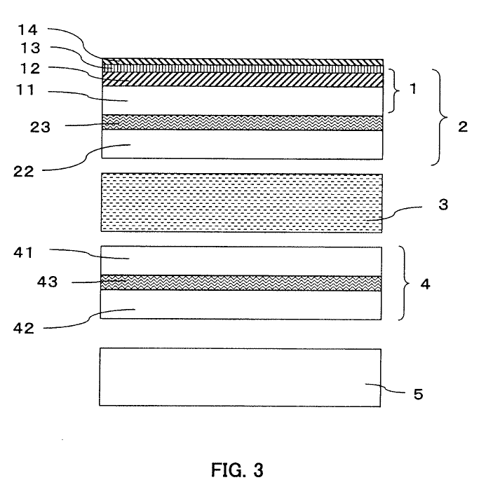

Next, a transmission type LCD which employs the anti-reflection film of the present invention is described. FIG. 3 illustrates a cross sectional exemplary diagram of a transmission type LCD having the anti-reflection film of the present invention. The transmission type LCD in FIG. 3 has a backlight unit 5, a polarizing plate 4, a liquid crystal cell 3 and a polarizing plate 2 including an anti-reflection film 1 in order. At this time, a side on which the anti-reflection film is arranged should be the observer's side, namely, the frontal surface of the display device.

The backlight unit includes a light source and a light diffuser. The liquid crystal cell has an electrode and a color filter on one transparent substrate and another electrode on the other transparent substrate, and a liquid crystal is inserted between these two electrodes. The liquid crystal cell is sandwiched by the two polarizing plates.

In addition, a transmission type LCD of the present invention may include other functional components. Although a prism sheet, a luminance improving film and a diffusion film, which serves to effectively use light from the backlight unit, and a retardation film, which compensates for a phase difference of the liquid crystal cell and/or the polarizing plate, are typical examples of such functional components, the present invention is not limited to these.

A manufacturing method of an anti-reflection film of the present invention is described below.

A variety of films and sheets made of various organic polymers can be used as the transparent substrate of an anti-reflection film of the present invention. For example, general materials used as a substrate of an optical component of a display device can be used. Considering optical properties such as transparency and refractive index etc. and other various properties such as impact resistance, heat resistance and durability etc., organic polymers of a polyolefin such as polyethylene and polypropylene etc., a polyester such as PET (polyethylene terephthalate) and PEN (polyethylene naphthalate) etc., a cellulose such as TAC (triacetyl cellulose), diacetyl cellulose and cellophane etc., a polyamide such as 6-nylon and 6,6-nylon etc., an acrylic polymer such as polymethyl methacrylate etc., polystyrene, polyvinyl chloride, polyimide, polyvinyl alcohol, polycarbonate and ethylene vinyl alcohol can be used. PET, TAC, polycarbonate and polymethyl methacrylate are particularly preferable. Among these, TAC can be preferably applied to an LCD because of its small birefringence and good transparency.

It is preferable that the thickness of the transparent substrate is in the range of 25-200 μm. 40-80-μm is more preferable.

Those organic polymers may be provided with some functionality by, for example, adding a publicly known additive such as an antistatic agent, an ultraviolet absorber, an infrared absorber, a plastic agent, a lubricant, a colorant, an antioxidant and a flame retardant etc. In addition, the transparent substrate may be a mixture or a copolymer of any combination of organic polymers noted above. Moreover, the transparent substrate may also have a multilayer structure.

Next, a method for forming a hard coat layer is described. A coating liquid for forming a hard coat layer, which contains an ionizing radiation curable material, is coated on a transparent substrate to form a coated layer. The coated layer is dried if necessary. Then, the coated layer is irradiated with ionizing radiation such as ultraviolet or an electron beam to form the hard coat layer by a curing reaction of the ionizing radiation curable material.

An acrylic material can be used as the ionizing radiation curable material for forming the hard coat layer. A polyfunctional (meth)acrylate such as an acrylic or methacrylic acid ester of polyol, and a polyfunctional urethane (meth)acrylate, which is synthesized from a diisocyanate, a polyol and a hydroxyester of acrylic or methacrylic acid, are available as the acrylic material. Besides these, a polyester resin, an epoxy resin, an alkyd resin, a spiroacetal resin, a polybutadiene resin, a polythiol polyen resin and a polyether resin which have an acrylate functional group can be used as the ionizing radiation curable material.

The term “(meth)acrylate” means both an “acrylate” and a “methacrylate”. For example, “urethane (meth)acrylate” means both “urethane acrylate” and “urethane methacrylate”.

Examples of monofunctional (meth)acrylate are 2-hydroxyethyl (meth) acrylate, 2-hydroxypropyl (meth)acrylate, 2-hydroxybutyl (meth) acrylate, n-butyl (meth)acrylate, isobutyl (meth)acrylate, t-butyl (meth)acrylate, glycidyl (meth)acrylate, acryloyl morpholine, N-vinyl pyrrolidone, tetrahydrofurfuryl acrylate, cyclohexyl (meth)acrylate, 2-ethylhexyl (meth)acrylate, isobornyl (meth)acrylate, isodecyl (meth)acrylate, lauryl (meth)acrylate, tridecyl (meth)acrylate, cetyl (meth) acrylate, stearyl (meth)acrylate, benzyl (meth)acrylate, 2-ethoxyethyl (meth)acrylate, 3-methoxybutyl (meth)acrylate, ethylcarbitol (meth)acrylate, (meth)acrylate phosphate, ethylene oxide modified (meth)acrylate phosphate, phenoxy(meth)acrylate, ethylene oxide modified phenoxy(meth)acrylate, propylene oxide modified phenoxy(meth)acrylate, nonylphenol (meth)acrylate, ethylene oxide modified nonylphenol (meth)acrylate, propylene oxide modified nonylphenol (meth)acrylate, methoxydiethylene glycol (meth)acrylate, methoxypolyethylene glycol (meth)acrylate, methoxypropylene glycol (meth)acrylate, 2-(meth)acryloyl oxyethyl-2-hydroxypropyl phthalate, 2-hydroxy-3-phenoxypropyl (meth)acrylate, 2-(meth)acryloyl oxyethyl hydrogen phthalate, 2-(meth)acryloyl oxypropyl hydrogen phthalate, 2-(meth)acryloyl oxypropyl hexahydro hydrogen phthalate, 2-(meth)acryloyl oxypropyl tetrahydro hydrogen phthalate, dimethylaminoethyl (meth)acrylate, trifluoroethyl (meth)acrylate, tetrafluoropropyl (meth)acrylate, hexafluoropropyl (meth)acrylate, octafluoropropyl acrylate (meth)acrylate, and an admantane derivative mono(meth)acrylate such as an adamantyl (meth)acrylate having mono(meth)acrylate derived from 2-adamantane and adamantanediol.

Examples of bifunctional (meth)acrylate are di(meth)acrylates such as ethylene glycol di(meth)acrylate, diethylene glycol di(meth)acrylate, butanediol di(meth)acrylate, hexanediol di(meth)acrylate, nonanediol di(meth)acrylate, ethoxylated hexanediol di(meth)acrylate, propoxylated hexanediol di(meth)acrylate, polyethylene glycol di(meth)acrylate, tripropylene glycol di(meth)acrylate, polypropylene glycol di(meth)acrylate, neopentyl glycol di(meth)acrylate, ethoxylated neopentyl glycol di(meth)acrylate, tripropylene glycol di(meth)acrylate, and hydroxypivalate neopentyl glycol di(meth)acrylate etc.

Examples of polyfunctional (meth)acrylate compound having more than two functional groups are tri(meth)acrylates such as trimethylolpropane tri(meth)acrylate, ethoxylated trimethylolpropane tri(meth)acrylate, propoxylated trimethylolpropane tri(meth)acrylate, tris 2-hydroxyethyl isocyanate tri(meth)acrylate and glycerol tri(meth)acrylate etc., trifunctional (meth)acrylate compounds such as pentaerythritol tri(meth)acrylate, dipentaerythritol tri(meth)acrylate and ditrimethylolpropane tri(meth)acrylate etc., polyfunctional (meth)acrylates and their derivative compounds in which some of the acrylate groups are substituted by an alkyl group or an ε-caprolacton group such as pentaerythritol tetra(meth)acrylate, ditrimethylolpropane tetra(meth)acrylate, dipentaerythritol tetra(meth)acrylate, dipentaerythritol penta(meth)acrylate, ditrimethylolpropane penta(meth)acrylate, dipentaerythritol hexa(meth)acrylate and ditrimethylolpropane hexa(meth)acrylate etc.

Among various acrylic materials, polyfunctional urethane acrylates are preferably used due to the capability of adjusting characteristics of the formed hard coat layer by designing a molecular structure with a desirable molecular weight. The urethane acrylates can be obtained by a reaction of a polyol, a polyisocyanate and an acrylate having a hydroxyl group. Specifically, UA-306H, UA-306T and UA-306I etc. made by Kyoeisha chemical Co., Ltd. UV-1700B, UV-6300B, UV-7600B, UV-7605B, UV-7640B and UV-7650B etc. made by Nippon Synthetic Chemical Industry Co., Ltd. U-4HA, U-6HA, UA-100H, U-6LPA, U-15HA, UA-32P and U-324A etc. made by Shin-Nakamura Chemical Co., Ltd. Ebecryl-1290, Ebecryl-1290K and Ebecryl-5129 etc. made by Daicel UCB Company Ltd. UN-3220HA, UN-3220HB, UN-3220HC and UN-3220HS etc. made by Negami Chemical Industrial Co., Ltd. can be used. However, the present invention is not limited to these.

Besides these, a polyester resin, an epoxy resin, an alkyd resin, a spiroacetal resin, a polybutadiene resin, a polythiol polyen resin and a polyether resin which have an acrylate functional group can be used as the ionizing radiation curable material.

In addition, a photopolymerization initiator is added to the coating liquid for forming the hard coat layer in the case where the coating liquid for forming the hard coat layer is cured by ultraviolet light. An additive which generates a radical as ultraviolet light is irradiated, for example, acetophenone, benzoin, benzophenone, phosphine oxide, ketals, anthraquinone and thioxanthone can be used as the photopolymerization initiator. In addition, the amount of photopolymerization initiator added to the coating liquid is in the range of 0.1-10 parts by weight, and is preferably in the range of 1-7 parts by weight (more preferably in the range of 1-5 parts by weight) relative to 100 parts by weight of ionizing radiation curable material.

Moreover, a solvent and/or various other additives may be added to the coating liquid for forming the hard coat layer, if necessary. Considering the coating suitability etc., the solvent can be preferably selected from aromatic hydrocarbons such as toluene, xylene and cyclohexylbenzene etc., hydrocarbons such as n-hexane and cyclohexane etc., ethers such as dibutyl ether, dimethoxymethane, dimethoxyethane, diethoxyethane, propylene oxide, dioxane, dioxolane, trioxane, tetrahydrofuran, anisole and phenetol etc., ketones such as methyl isobutyl ketone, methyl butyl ketone, acetone, methyl ethyl ketone, diethyl ketone, dipropyl ketone, diisobutyl ketone, cyclopentanone, cyclohexanone and methylcyclohexanone etc., esters such as ethyl formate, propyl formate, n-pentyl formate, methyl acetate, ethyl acetate, methyl propionate, ethyl propionate, n-pentyl acetate and γ-butyrolactone etc., and cellosolves such as methyl cellosolve, cellosolve, butyl cellosolve and cellosolve acetate etc. In addition, a surface conditioner, a refractive index adjuster, an adhesiveness improver and curing agent etc. can be added to the coating liquid as the additives.

It is preferable that the solvent for the coating liquid for forming the hard coat layer contains a solvent which dissolves the transparent substrate. A mixed layer, in which the transparent substrate component and the hard coat layer component is mixed, is formed by admixing the coating liquid for forming the hard coat layer with a solvent which dissolves the transparent substrate. The mixed layer improves adhesiveness between the hard coat layer and the transparent substrate. In addition, it is possible to prevent an occurrence of interference unevenness caused by an optical interference between the transparent substrate and the hard coat layer.

In addition, particles having an average diameter of 100 nm or less may be added to the coating liquid for forming the hard coat layer in order to improve surface hardness of the hard coat layer.

In addition, other additives may be added to the coating liquid for forming the hard coat layer. Antifoam, a leveling agent, an antioxidant, an ultraviolet absorber, an optical stabilizer and a polymerization inhibitor, are examples of the additives. However, the present invention is not limited to these.

The hard coat layer is formed by preparing the coating liquid for forming the hard coat layer described above followed by coating it on the transparent substrate by a wet coating method to form a coated layer, drying the coated layer if necessary, and irradiating with ionizing radiation such as ultraviolet light or an electron beam.

At this time, a coating method using a roll coater, a reverse roll coater, a gravure coater, a micro gravure coater, a knife coater, a bar coater, a wire bar coater, a die coater or a dip coater can be employed as the wet coating method.

The hard coat layer is formed by irradiating the coated layer, which is obtained by coating the coating liquid for forming the hard coat layer on the transparent substrate, with ionizing radiation. Ultraviolet radiation and/or an electron beam can be used as the ionizing radiation. In the case of ultraviolet curing, a light source such as a high-pressure mercury lamp, a low-pressure mercury lamp, an ultrahigh-pressure mercury lamp, a metal halide lamp, a carbon arc, or a xenon arc can be used. In the case of electron beam curing, an electron beam emitted from various electron beam accelerators such as a Cockroft-Walton accelerator, a Van de Graaff accelerator, a resonance transformer-type accelerator, an insulating core transformer-type accelerator, a linear accelerator, a dynamitron accelerator, or a high-frequency accelerator can be used.

A drying process or a heating process may be arranged before or after the process of forming the hard coat layer by curing. In the case where the coating liquid contains a solvent in particular, it is necessary to perform a drying treatment before the irradiation of ionizing radiation in order to remove the solvent in the coated layer. Heating, air blow and/or hot air blow etc. are examples of the drying treatment.

It is preferable in an anti-reflection film of the present invention that pencil hardness of the hard coat layer is H or higher in order to obtain abrasion resistance.

In addition, a thermoplastic resin may be added to the coating liquid to prevent the anti-reflection film with the hard coat layer from curling. The hard coat layer is formed in the way described above.

A surface treatment such as acid treatment, alkali treatment, corona treatment and/or atmospheric pressure glow discharge plasma treatment etc. may be performed before forming the antistatic layer on the hard coat layer. It is possible to further improve adhesiveness between the hard coat layer and the antistatic layer by these surface treatments.

In the case where an antistatic layer in which a metal alkoxide or silicon alkoxide is used as the binder matrix is formed on the hard coat layer, it is preferable to perform alkali treatment before the antistatic layer is formed. It is possible to improve adhesiveness between the hard coat layer and the antistatic layer by the alkali treatment so as to further improve the abrasion resistance of the anti-reflection film.

It is possible to form the antistatic layer of the present invention by coating a coating liquid for forming an antistatic layer, which contains conductive materials and the binder matrix forming material, on the transparent substrate.

It is possible to use inorganic conductive particles made of metal particles and/or conductive metal oxide particles such as indium oxide, tin oxide, indium oxide-tin oxide (ITO), zinc oxide, zinc oxide-aluminum oxide (AZO), zinc oxide-gallium oxide (AZO), indium oxide-cerium oxide, antimony oxide, antimony oxide-tin oxide (ATO) and tungsten oxide etc. as the conductive materials.

In particular, if metal oxide particles of tin oxide series such as tin oxide, antimony-doped tin oxide (ATO), phosphor-doped tin oxide (PTO), fluorine-doped tin oxide (FTO) and indium oxide-tin oxide (ITO), it is possible to provide the anti-reflection film with increasing absorption loss in light transmittance at various wavelengths in the visible light region as the wavelength increases. As a result, it is possible to easily manufacture an anti-reflection film which satisfies Q₄₅₀<Q₅₅₀<Q₆₅₀ relating to absorption losses in light transmittance.

In addition, polyacetylene, polyaniline, polythiophene, polypyrrole, polyphenylene sulfide, poly(1, 6-heptadiyne), polybiphenylene (polyp araphenylene), poly(paraphenylene sulfide), polyphenylacetylene, poly(2,5-phenylene) and a derivative of these, and a blend of these (including a blend of derivatives of these) can be used as the conductive polymer (electron conductive type). An ionizing radiation curable organic conductive polymer, which cures by irradiating with ionizing radiation after thermal drying, can preferably be used as the conductive polymer. In particular, polythiophene and its derivatives are preferably used as the conductive polymer.

It is preferable that the inorganic conductive particles which are used in the antistatic layer of the present invention have an average particle diameter in the range of 1-100 nm. In the case where the average particle diameter exceeds 100 nm, the anti-reflection film excessively reflects light by Rayleigh scattering and is liable to have a whitely clouded conductive layer so that the transparency of the anti-reflection film declines. On the other hand, in the case where the average particle diameter is less than 1 nm, problems such as low conductivity and uneven particle distribution may occur due to an agglutination of the particles in the conductive layer.

A silicon alkoxide hydrolysate can be used as the binder matrix forming material. It is possible to use a silicon alkoxide hydrolysate which is expressed by a chemical formula (1): RₓSi(OR′)₄₋ₓ, where R and R′ are alkyl groups and x is an integer satisfying 0≦x≦3.

For example, tetramethoxysilane, tetraethoxysilane, tetra-iso-propoxysilane, tetra-n-propoxysilane, tetra-n-butoxysilane, tetra-sec-butoxysilane, tetra-tert-butoxysilane, tetrapentaethoxysilane, tetrapenta-iso-propoxysilane, tetrapenta-n-propoxysilane, tetrapenta-n-butoxysilane, tetrapenta-sec-butoxysilane, tetrapenta-tert-butoxysilane, methyltrimethoxysilane, methyltriethoxysilane, methyltripropoxysilane, methyltributoxysilane, dimethyldimethoxysilane, dimethyldiethoxysilane, dimethylethoxysilane, dimethylmethoxysilane, dimethylpropoxysilane, dimethylbutoxysilane, methyldimethoxysilane, methyldiethoxysilane and hexyltrimethoxysilane etc. can be used as the silicon alkoxide which is expressed by the chemical formula (1). The silicon alkoxide hydrolysate is obtained from the silicon alkoxides of the chemical formula (1) by, for example, a hydrolysis with hydrochloric acid.

Moreover, the silicon alkoxide expressed by the chemical formula (1): RₓSi(OR′)₄₋ₓ, where R and R′ are alkyl groups and x is an integer satisfying 0≦x≦3, and further admixed with a silicon alkoxide expressed by a chemical formula (2): R″_{y}Si(OR′)_{4-y}, where R″ is a reactive functional group, R′ is an alkyl group and y is an integer satisfying 1≦x≦3, can also be used as the silicon alkoxide. At this time, either an epoxy group or a glycidoxy group is preferably used as the reactive function group. It is preferable that the silicon alkoxide of the chemical formula (2) is contained by a ratio in the range of 0.5-30 mol % relative to all of the silicon alkoxide, and is more preferable that the silicon alkoxide of the chemical formula (2) is contained by a ratio in the range of 4-12 mol %. It is possible to improve weather resistance by an addition of the silicon alkoxide of the chemical formula (2) which includes a reactive functional group.

In addition, it is also possible to use an ionizing radiation curable material as the binder matrix forming material. Acrylic materials which are noted as examples of the ionizing radiation curable material contained in the coating liquid for forming the hard coat layer can be used as this ionizing radiation curable material. Besides these, polyether resin, polyester resin, epoxy resin, alkyd resin, spiroacetal resin, polybutadiene resin and polythiol-polyene resin having an acrylic functional group can also be used as the ionizing radiation curable material.

In the case where a silicon alkoxide hydrolysate is used as the binder matrix forming material, the coating liquid for forming the antistatic layer which contains the silicon alkoxide hydrolysate and the conductive particles is coated on the transparent substrate to form a coated layer, and after the coated layer is dried and heated, the antistatic layer is formed producing a binder matrix by dehydrocondensation of silicon alkoxide. In the case where an ionizing radiation curable material is used as the binder matrix forming material, the coating liquid for forming the antistatic layer which contains the ionizing radiation curable material and the conductive particles is coated on the transparent substrate to form a coated layer, and after the coated layer is dried if necessary, the antistatic layer is formed producing a binder matrix by performing a curing reaction by irradiation of ionizing radiation such as ultraviolet light and an electron bean. At this time, a coating method using a roll coater, a reverse roll coater, a gravure coater, a micro gravure coater, a knife coater, a bar coater, a wire bar coater, a die coater and a dip coater can be employed as the coating method.

Moreover, a solvent and/or various additives may be added to the coating liquid for forming the antistatic layer, if necessary. Considering the coating suitability etc., the solvent can be preferably selected from aromatic hydrocarbons such as toluene, xylene and cyclohexylbenzene etc., hydrocarbons such as n-hexane and cyclohexane etc., ethers such as dibutyl ether, dimethoxymethane, dimethoxyethane, diethoxyethane, propylene oxide, dioxane, dioxolane, trioxane, tetrahydrofuran, anisole and phenetol etc., ketones such as methyl isobutyl ketone, methyl butyl ketone, acetone, methyl ethyl ketone, diethyl ketone, dipropyl ketone, diisobutyl ketone, cyclopentanone, cyclohexanone and methylcyclohexanone etc., esters such as ethyl formate, propyl formate, n-pentyl formate, methyl acetate, ethyl acetate, methyl propionate, ethyl propionate, n-pentyl acetate and γ-butyrolactone etc., cellosolves such as methyl cellosolve, cellosolve, butyl cellosolve and cellosolve acetate etc., alcohols such as methanol, ethanol and isopropyl alcohol etc., and water etc. In addition, a surface conditioner, an antistatic agent, an antifouling agent, a water repellent, a refractive index adjuster, an adhesiveness improver and curing agent etc. can be added to the coating liquid as the additives.

A method for forming the low refractive index layer is described. The low refractive index layer of the present invention can be formed by coating a coating liquid which contains low refractive index particles and the binder matrix by a wet coating method.

Particles made of low refractive index materials such as LiF, MgF, 3NaF.AlF or AlF, each of which has a refractive index of 1.4, or Na₃AlF₆ (cryolite, refractive index: 1.33) etc. can be used as the low refractive particles. In addition, particles which include pores inside can also be preferably used. Such particles have a significantly low refractive index since the pores can be considered to have a refractive index of air (namely, almost equal to 1.0). Practically, low refractive index silica particles having pores inside can be used as the particles.

It is preferable that the low refractive index particles used in the low refractive index layer of the present invention have a size (diameter) in the range of 1-100 nm. If the particles have a diameter more than 100 nm, light is severely reflected by Rayleigh scattering and the low refractive index layer is inclined to be whitely clouded resulting in degradation in transparency of the antireflection film. On the other hand, if the particles have a diameter less than 1 nm, there is a problem of an uneven distribution of the particles in the low refractive index layer caused by an agglutination of the particles.

A silicon alkoxide hydrolysate can be used as the binder matrix forming material. More specifically, a hydrolysate of a silicon alkoxide which is generally expressed by the chemical formula (1): RₓSi(OR′)₄₋ₓ, where R and R′ refer to alkyl groups and x is an integer which satisfies 0≦x≦3.

For example, tetramethoxysilane, tetraethoxysilane, tetraisopropoxysilane, tetra-n-propoxysilane, tetra-n-b utoxysilane, tetra-sec-butoxysilane, tetra-tert-butoxy silane, tetrapentaethoxysilane, tetrapenta-iso-propoxysilane, tetrapenta-n-propoxysilane, tetrapenta-n-butoxysilane, tetrapenta-sec-butoxysilane, tetrapenta-tert-butoxysilane, methyltrimethoxysilane, methyltriethoxysilane, methyltripropoxysilane, methyltributoxysilane, dimethyldimethoxysilane, dimethyldiethoxysilane, dimethylethoxysilane, dimethylpropoxysilane, dimethylbutoxysilane, methyldimethoxysilane, methyldiethoxysilane and hexyltrimethoxysilane etc. can be used as the silicon alkoxide which is expressed as the Formula 1. The hydrolysate of a silicon alkoxide which is expressed as the Formula 1 can be obtained by, for example, a hydrolysis reaction with hydrochloric acid.

Furthermore, a blend material which is obtained by adding a hydrolysate of a silicon alkoxide generally expressed as a chemical formula (3): R′″_{z}Si(OR′)_{4-z} (where R′ refers to a non-reactive functional group having an alkyl group, R′″ refers to a fluoroalkyl group or a fluoroalkylene group and z is an integer which satisfies 0≦z≦3.) to a hydrolysate of a silicon alkoxide expressed as the chemical formula (1) mentioned above can be used as the binder matrix forming material of the low refractive index layer. Then, it is possible to provide the low refractive index layer surface with antifouling properties and to make the refractive index of the low refractive index layer even lower.

Octadecyltrimethylsilane and 1H,1H,2H,2H-perfluorooctyltrimethoxysilane etc. are examples of the hydrolysate of a silicon alkoxide expressed as the chemical formula (3).

In addition, an ionizing radiation curable material can also be used as the binder matrix forming material. Acrylic materials which were noted as examples of the ionizing radiation curable material contained in the coating liquid for forming the hard coat layer can be used as this ionizing radiation curable material. Besides these, a polyether resin, a polyester resin, an epoxy resin, an alkyd resin, a spiroacetal resin, a polybutadiene resin and a polythiol polyen resin which have an acrylic functional group etc. can also be used as the binder matrix forming material.

In the case where a silicon alkoxide hydrolysate is used as the binder matrix forming material, the coating liquid for forming the low refractive index layer which contains the silicon alkoxide hydrolysate and the low refractive index particles is coated on the transparent substrate to form a coated layer, and after the coated layer is dried and heated, the lower layer of the low refractive index layer is formed producing a binder matrix by dehydrocondensation of silicon alkoxide. In the case where an ionizing radiation curable material is used as the binder matrix forming material, the coating liquid which contains the ionizing radiation curable material and the low refractive index particles is coated on the transparent substrate to form a coated layer, and after the coated layer is dried if necessary, the low refractive index layer is formed producing a binder matrix by performing a curing reaction by irradiation of ionizing radiation such as ultraviolet light and an electron bean. At this time, a coating method using a roll coater, a reverse roll coater, a gravure coater, a micro gravure coater, a knife coater, a bar coater, a wire bar coater, a die coater and a dip coater can be employed as the coating method.

Moreover, a solvent and/or various additives may be added to the coating liquid for forming the low refractive index layer, if necessary. Considering the coating suitability etc., the solvent can be preferably selected from aromatic hydrocarbons such as toluene, xylene and cyclohexylbenzene etc., hydrocarbons such as n-hexane and cyclohexane etc., ethers such as dibutyl ether, dimethoxymethane, dimethoxyethane, diethoxyethane, propylene oxide, dioxane, dioxolane, trioxane, tetrahydrofuran, anisole and phenetol etc., ketones such as methyl isobutyl ketone, methyl butyl ketone, acetone, methyl ethyl ketone, diethyl ketone, dipropyl ketone, diisobutyl ketone, cyclopentanone, cyclohexanone and methylcyclohexanone etc., esters such as ethyl formate, propyl formate, n-pentyl formate, methyl acetate, ethyl acetate, methyl propionate, ethyl propionate, n-pentyl acetate and γ-butyrolactone etc., cellosolves such as methyl cellosolve, cellosolve, butyl cellosolve and cellosolve acetate etc., alcohols such as methanol, ethanol and isopropyl alcohol etc., and water etc. In addition, a surface conditioner, a leveling agent, a refractive index adjuster, an adhesiveness improver and a photosensitizer etc. can be added to the coating liquid as the additives.

In the case where an ionizing radiation curable material is used as the binder matrix and the low refractive index layer is formed by irradiation of ultraviolet light, the coating liquid for forming the low refractive index layer is admixed with a photopolymerization initiator. Examples of the photopolymerization initiator are acetophenone, benzoin, benzophenone, phosphine oxide, ketals, anthraquinone and thioxanthone etc. The low refractive index layer is formed as described above.

It is preferable that the coating liquid for forming the low refractive index layer contains a silicone and/or a fluorocompound such as silicon alkoxides which are expressed as the chemical formula (3). Even in the case where ionizing radiation curable material is used as the binder matrix forming material, it is preferable that the coating liquid containing a silicone and/or a fluorocompound, whereby the low refractive index layer surface of the anti-reflection film is provided with antifouling properties and abrasion resistance so that the film is preferably applied on a surface of a display device.

In this way, an anti-reflection film of the present invention is manufactured. If a polarizing layer and another transparent substrate are arranged on the opposite surface of the original transparent substrate in the anti-reflection film of the present invention from the side on which the anti-reflection layer is formed, a polarizing plate can be produced. An iodine-added elongated polyvinyl alcohol (PVA) can be used as the polarizing layer. In addition, a transparent substrate used in the anti-reflection film, preferably a triacetyl cellulose film can be used as the ‘another transparent substrate’.

In addition, an anti-reflection film is made into a polarizing plate and arranged on the frontal surface of a transmission type LCD, namely, the observer's side in a way that the anti-reflection layer is arranged on the front. It is possible to provide a transmission type LCD having excellent antistatic function, anti-reflection function and reflection light with reduced color.

### EXAMPLE

### Example 1

### Transparent Substrate

An 80 μm thick triacetyl cellulose film as the transparent substrate and a polarizing plate in which an iodine-added elongated polyvinyl alcohol was interposed between two 80 μm thick triacetyl cellulose films were prepared. <Formation of Hard Coat Layer>

10 parts by weight of dipentaerythritol triacrylate and 10 parts by weight of pentaerythritol tetraacrylate and 30 parts by weight of urethane acrylate (UA-306T, made by Kyoeisha chemicals Co., Ltd.) as the ionizing radiation curable materials, 2.5 parts by weight of Irgacure 184 (made by Ciba Japan Co., Ltd.) as the photopolymerization initiator, and 25 parts by weight of methyl ethyl ketone and 25 parts by weight of butyl acetate as the solvents were blended together to prepare the coating liquid for forming the hard coat layer. The coating liquid for forming the hard coat layer was coated on the triacetyl cellulose film by a wire bar coater. After the triacetyl cellulose film coated with the coating liquid for forming the hard coat layer was dried in an oven at 80° C. for one minute, a hard coat layer was formed by irradiating with 120 W output power of ultraviolet light for 10 seconds from a point 20 cm away using a metal halide lamp. The resultant hard coat layer was 5 μm in thickness and 1.52 in refractive index.

<Formation of antistatic layer>

Tetraethoxysilane as the raw material was added with isopropyl alcohol and 0.1N hydrochloric acid to hydrolyze so that a solution containing a tetraethoxysilane oligomer was obtained as the organic silicon compound. This solution was admixed with antimony doped tin oxide (ATO) particles having 8 nm of primary particle diameter and further added with isopropyl alcohol to obtain the coating liquid for forming the antistatic layer which contains 2.5 parts by weight of tetraethoxysilane polymer (oligomer) and 2.5 parts by weight of ATO particles per 100 parts by weight of the coating liquid. The triacetyl cellulose film on which the hard coat layer was formed was dipped in 50° C. of 1.5N—NaOH aqueous solution for two minutes to receive an alkali treatment. After washing with water, the film was subsequently dipped in 0.5 wt % of H₂SO₄ aqueous solution for 30 seconds at room temperature to neutralize followed by washing with water and drying. The coating liquid for forming the antistatic layer was coated on the alkali-treated hard coat layer by a wire bar coater and was dried with heat in an oven at 120° C. for one minute to form the antistatic layer. The resultant antistatic layer was 163 nm in thickness, 1.53 in refractive index and 250 nm in optical thickness.

### <Formation of Low Refractive Index Layer>

A 95:5 by molar ratio mixture of tetraethoxysilane and 1H, 1H, 2H, 2H-perfluorooctyltrimethoxysilane was used as the organic silicon compound and added with isopropyl alcohol and 0.1N hydrochloric acid to hydrolyze so that a solution containing oligomers of the organic silicon compound was obtained. The resultant solution was admixed with a dispersion liquid of low refractive index silica particles having an inner pore (primary particle diameter: 30 nm, solid content: 20% by weight) and added with isopropyl alcohol to obtain the coating liquid for forming the low refractive index layer which contains 2.0 parts by weight of the organic silicon compound and 2.0 parts by weight of the low refractive index silica particles per 100 parts by weight of the coating liquid. The obtained coating liquid for forming the low refractive index layer was coated on the antistatic layer by a wire bar coater and was dried with heat in an oven at 120° C. for one minute to form the low refractive index layer. The resultant low refractive index layer was 91 nm in thickness, 1.37 in refractive index and 125 nm in optical thickness.

In this way, an anti-reflection film having a transparent substrate, a hard coat layer, an antistatic layer and a low refractive index layer in order, and a polarizing plate having a hard coat layer, an antistatic layer and a low refractive index layer in order on a polarizing plate which includes a transparent substrate, a polarizing layer and another transparent substrate were manufactured.

### Example 2

### Transparent Substrate

The same triacetyl cellulose film and polarizing plate as those in <<Example 1>> were prepared.

### <Formation of Hard Coat Layer>

A hard coat layer was formed in a similar way to that in <<Example 1>>. The resultant hard coat layer was 5 μm in thickness and 1.52 in refractive index.

### <Formation of Antistatic Layer>

An antistatic layer was formed in a similar way to that in <<Example 1>>. The resultant antistatic layer was 163 nm in thickness, 1.53 in refractive index and 250 nm in optical thickness.

### <Formation of Low Refractive Index Layer>

A 95:5 by molar ratio mixture of tetraethoxysilane and 1H, 1H, 2H, 2H-perfluorooctyltrimethoxysilane was used as the organic silicon compound and added with isopropyl alcohol and 0.1N hydrochloric acid to hydrolyze so that a solution containing oligomers of the organic silicon compound was obtained. The resultant solution was admixed with a dispersion liquid of low refractive index silica particles having an inner pore (primary particle diameter: 30 nm, solid content: 20% by weight) and added with isopropyl alcohol to obtain the coating liquid for forming the low refractive index layer which contains 1.8 parts by weight of the organic silicon compound and 2.0 parts by weight of the low refractive index silica particles per 100 parts by weight of the coating liquid. The obtained coating liquid for forming the low refractive index layer was coated on the antistatic layer by a wire bar coater and was dried with heat in an oven at 120° C. for one minute to form the low refractive index layer. The resultant low refractive index layer was 94 nm in thickness, 1.33 in refractive index and 125 nm in optical thickness.

In this way, an anti-reflection film having a transparent substrate, a hard coat layer, an antistatic layer and a low refractive index layer in order, and a polarizing plate having a hard coat layer, an antistatic layer and a low refractive index layer in order on a polarizing plate which includes a transparent substrate, a polarizing layer and another transparent substrate were manufactured.

### Example 3

### Transparent Substrate

The same triacetyl cellulose film and polarizing plate as those in <<Example 1>> were prepared.

### <Formation of Hard Coat Layer>

A hard coat layer was formed in a similar way to that in <<Example 1>>. The resultant hard coat layer was 5 μm in thickness and 1.52 in refractive index.

### <Formation of Antistatic Layer>

Tetraethoxysilane as the raw material was added with isopropyl alcohol and 0.1N hydrochloric acid to hydrolyze so that a solution containing a tetraethoxysilane oligomer was obtained as the organic silicon compound. This solution was admixed with phosphor doped tin oxide (PTO) particles having 8 nm of primary particle diameter and further added with isopropyl alcohol to obtain the coating liquid for forming the antistatic layer which contains 2.0 parts by weight of tetraethoxysilane polymer (oligomer) and 3.0 parts by weight of PTO particles per 100 parts by weight of the coating liquid. The triacetyl cellulose film on which the hard coat layer was formed was dipped in 50° C. of 1.5N—NaOH aqueous solution for two minutes to receive an alkali treatment. After washing with water, the film was subsequently dipped in 0.5 wt % of H₂SO₄ aqueous solution for 30 seconds at room temperature to neutralize followed by washing with water and drying. The coating liquid for forming the antistatic layer was coated on the alkali-treated hard coat layer by a wire bar coater and was dried with heat in an oven at 120° C. for one minute to form the antistatic layer. The resultant antistatic layer was 181 nm in thickness, 1.54 in refractive index and 279 nm in optical thickness.

### <Formation of Low Refractive Index Layer>

A low refractive index layer was formed in a similar way to that in <<Example 1>>. The resultant hard coat layer was 91 nm in thickness, 1.37 in refractive index and 125 nm in optical thickness.

In this way, an anti-reflection film having a transparent substrate, a hard coat layer, an antistatic layer and a low refractive index layer in order, and a polarizing plate having a hard coat layer, an antistatic layer and a low refractive index layer in order on a polarizing plate which includes a transparent substrate, a polarizing layer and another transparent substrate were manufactured.

### Example 4

### Transparent Substrate

The same triacetyl cellulose film and polarizing plate as those in <<Example 1>> were prepared.

### <Formation of Hard Coat Layer>

A hard coat layer was formed in a similar way to that in <<Example 1>>. The resultant hard coat layer was 5 μm in thickness and 1.52 in refractive index.

### <Formation of Antistatic Layer>

An antistatic was formed in a similar way to that in <<Example 1>>. The resultant antistatic layer was 163 nm in thickness, 1.53 in refractive index and 250 nm in optical thickness.

### <Formation of Low Refractive Index Layer>

8.0 parts by weight of dispersion liquid of low refractive index silica particles having an inner pore (primary particle diameter: 30 nm, solid content: 20% by weight), 2.4 parts by weight of dipentaerythritol hexaacrylate (DPHA) as an ionizing radiation curable material, 0.2 parts by weight of TSF44 (made by Toshiba GE silicone inc.) as a silicone additive, 0.2 parts by weight of Irgacure184 (by Ciba Japan Inc.) as a photopolymerization initiator and 89.6 parts by weight of methyl isobutyl ketone as a solvent are blended together to prepare the coating liquid for forming the low refractive index layer. The obtained coating liquid was coated on the antistatic hard coat layer by a wire bar coater to form the coated layer. After drying in an oven, the coated layer was cured by conveyer type UV curing equipment at an exposure amount of 500 mJ/cm² so that the low refractive index layer was formed. The resultant low refractive index layer was 94 nm in thickness, 1.39 in refractive index and 130 nm in optical thickness.

In this way, an anti-reflection film having a transparent substrate, a hard coat layer, an antistatic layer and a low refractive index layer in order, and a polarizing plate having a hard coat layer, an antistatic layer and a low refractive index layer in order on a polarizing plate which includes a transparent substrate, a polarizing layer and another transparent substrate were manufactured.

### Example 5

### Transparent Substrate

The same triacetyl cellulose film and polarizing plate as those in <<Example 1>> were prepared.

### <Formation of Hard Coat Layer>

A hard coat layer was formed in a similar way to that in <<Example 1>>. The resultant hard coat layer was 5 μm in thickness and 1.52 in refractive index.

### <Formation of Antistatic Layer>

Tetraethoxysilane as the raw material was added with isopropyl alcohol and 0.1N hydrochloric acid to hydrolyze so that a solution containing a tetraethoxysilane oligomer was obtained as the organic silicon compound. This solution was admixed with indium oxide tin oxide (ITO) particles having 40 nm of primary particle diameter and further added with dispersion liquid of low refractive index silica particles having an inner pore (primary particle diameter: 30 nm, solid content: 20% by weight) and isopropyl alcohol to obtain the coating liquid for forming the antistatic layer which contains 3.0 parts by weight of tetraethoxysilane polymer (oligomer), 5.0 parts by weight of ITO particles and 2.0 parts by weight of low refractive index silica particles per 100 parts by weight of the coating liquid. The triacetyl cellulose film on which the hard coat layer was formed was dipped in 50° C. of 1.5N—NaOH aqueous solution for two minutes to receive an alkali treatment. After washing with water, the film was subsequently dipped in 0.5 wt % of H₂SO₄ aqueous solution for 30 seconds at room temperature to neutralize followed by washing with water and drying. The coating liquid for forming the antistatic layer was coated on the alkali-treated hard coat layer by a wire bar coater and was dried with heat in an oven at 120° C. for one minute to form the antistatic layer. The resultant antistatic layer was 180 nm in thickness, 1.55 in refractive index and 279 nm in optical thickness.

### <Formation of Low Refractive Index Layer>

A 95:5 by molar ratio mixture of tetraethoxysilane and 1H, 1H, 2H, 2H-perfluorooctyltrimethoxysilane was used as the organic silicon compound and added with isopropyl alcohol and 0.1N hydrochloric acid to hydrolyze so that a solution containing oligomers of the organic silicon compound was obtained. The resultant solution was admixed with a dispersion liquid of low refractive index silica particles having an inner pore (primary particle diameter: 30 nm, solid content: 20% by weight) and added with isopropyl alcohol to obtain the coating liquid for forming the low refractive index layer which contains 1.7 parts by weight of the organic silicon compound and 2.3 parts by weight of the low refractive index silica particles per 100 parts by weight of the coating liquid. The obtained coating liquid for forming the low refractive index layer was coated on the antistatic layer by a wire bar coater and was dried with heat in an oven at 120° C. for one minute to form the low refractive index layer. The resultant low refractive index layer was 100 nm in thickness, 1.32 in refractive index and 132 nm in optical thickness.

In this way, an anti-reflection film having a transparent substrate, a hard coat layer, an antistatic layer and a low refractive index layer in order, and a polarizing plate having a hard coat layer, an antistatic layer and a low refractive index layer in order on a polarizing plate which includes a transparent substrate, a polarizing layer and another transparent substrate were manufactured.

### Comparative Example 1

### Transparent Substrate

The same polarizing plate as that in <<Example 1>> was prepared.

### <Formation of Hard Coat Layer>

A hard coat layer was formed in a similar way to that in <<Example 1>>. The resultant hard coat layer was 5 μm in thickness and 1.52 in refractive index.

In this way, a polarizing plate having a hard coat layer on a polarizing plate which includes a transparent substrate, a polarizing layer and another transparent substrate was manufactured.

### Comparative Example 2

### Transparent Substrate

The same triacetyl cellulose film and polarizing plate as those in <<Example 1>> were prepared.

### <Formation of Hard Coat Layer>

A hard coat layer was formed in a similar way to that in <<Example 1>>. The resultant hard coat layer was 5 μm in thickness and 1.52 in refractive index.

### <Formation of Low Refractive Index Layer>

A low refractive index layer was formed in a similar way to that in <<Example 1>>. The resultant hard coat layer was 91 nm in thickness, 1.37 in refractive index and 125 nm in optical thickness.

In this way, an anti-reflection film having a transparent substrate, a hard coat layer and a low refractive index layer in order, and a polarizing plate having a hard coat layer and a low refractive index layer in order on a polarizing plate which includes a transparent substrate, a polarizing layer and another transparent substrate were manufactured.

### Comparative Example 3

### Transparent Substrate

The same triacetyl cellulose film and polarizing plate as those in <<Example 1>> were prepared.

### <Formation of Hard Coat Layer>

A hard coat layer was formed in a similar way to that in <<Example 1>>. The resultant hard coat layer was 5 μm in thickness and 1.52 in refractive index.

### <Formation of Antistatic Layer>

5.0 parts by weight of antimony pentaoxide particles having 20 nm of primary particle diameter, 5.0 parts by weight of dipentaerythritol triacrylate as an ionizing radiation curable material, 0.25 parts by weight of Irgacure 184 (by Ciba Japan Inc.) as a photopolymerization initiator and 95 parts by weight of methyl isobutyl ketone as a solvent are blended together to prepare the coating liquid for forming the antistatic layer. The obtained coating liquid was coated on the antistatic hard coat layer by a wire bar coater to form the coated layer. After drying in an oven, the coated layer was cured by conveyer type UV curing equipment at an exposure amount of 500 mJ/cm² so that the antistatic layer was formed. The resultant antistatic layer was 78 nm in thickness, 1.60 in refractive index and 125 nm in optical thickness.

### <Formation of Low Refractive Index Layer>

A low refractive index layer was formed in a similar way to that in <<Example 1>>. The resultant hard coat layer was 91 nm in thickness, 1.37 in refractive index and 125 nm in optical thickness.

In this way, an anti-reflection film having a transparent substrate, a hard coat layer, an antistatic layer and a low refractive index layer in order, and a polarizing plate having a hard coat layer, an antistatic layer and a low refractive index layer in order on a polarizing plate which includes a transparent substrate, a polarizing layer and another transparent substrate were manufactured.

### Comparative Example 4

### Transparent Substrate

The same triacetyl cellulose film and polarizing plate as those in <<Example 1>> were prepared.

### <Formation of Hard Coat Layer>

A hard coat layer was formed in a similar way to that in <<Example 1>>. The resultant hard coat layer was 5 μm in thickness and 1.52 in refractive index.

### <Formation of Antistatic Layer>

Tetraethoxysilane as the raw material was added with isopropyl alcohol and 0.1N hydrochloric acid to hydrolyze so that a solution containing a tetraethoxysilane oligomer was obtained as the organic silicon compound. This solution was admixed with antimony pentaoxide particles having 20 nm of primary particle diameter and further added with isopropyl alcohol to obtain the coating liquid for forming the antistatic layer which contains 2.5 parts by weight of tetraethoxysilane polymer (oligomer) and 2.5 parts by weight of antimony pentaoxide particles per 100 parts by weight of the coating liquid. The triacetyl cellulose film on which the hard coat layer was formed was dipped in 50° C. of 1.5N—NaOH aqueous solution for two minutes to receive an alkali treatment. After washing with water, the film was subsequently dipped in 0.5 wt % of H₂SO₄ aqueous solution for 30 seconds at room temperature to neutralize followed by washing with water and drying. The coating liquid for forming the antistatic layer was coated on the alkali-treated hard coat layer by a wire bar coater and was dried with heat in an oven at 120° C. for one minute to form the antistatic layer. The resultant antistatic layer was 180 nm in thickness, 1.55 in refractive index and 279 nm in optical thickness.

### <Formation of Low Refractive Index Layer>

A low refractive index layer was formed in a similar way to that in <<Example 1>>. The resultant hard coat layer was 91 nm in thickness, 1.37 in refractive index and 125 nm in optical thickness.

In this way, an anti-reflection film having a transparent substrate, a hard coat layer, an antistatic layer and a low refractive index layer in order, and a polarizing plate having a hard coat layer, an antistatic layer and a low refractive index layer in order on a polarizing plate which includes a transparent substrate, a polarizing layer and another transparent substrate were manufactured.

### Comparative Example 5

### Transparent Substrate

An 80 μm thick triacetyl cellulose film as the transparent substrate and a polarizing plate in which an iodine-added elongated polyvinyl alcohol is interposed between two 80 μm thick triacetyl cellulose film were prepared.

### <Formation of Antistatic Hard Coat Layer>

10 parts by weight of dipentaerythritol triacrylate and 10 parts by weight of pentaerythritol tetraacrylate and 30 parts by weight of urethane acrylate (UA-306T, made by Kyoeisha chemicals Co., Ltd.) as the ionizing radiation curable materials, 2.5 parts by weight of Irgacure 184 (made by Ciba Japan Co., Ltd.) as the photopolymerization initiator, 12 parts by weight of antimony doped tin oxide (ATO) particles which has 8 nm of primary particle diameter, and 50 parts by weight of methyl ethyl ketone and 25 parts by weight of butyl acetate as the solvents were blended together to prepare the coating liquid for forming the hard coat layer. The coating liquid for forming the hard coat layer was coated on the triacetyl cellulose film by a wire bar coater. After the triacetyl cellulose film coated with the coating liquid for forming the hard coat layer was dried in an oven at 80° C. for one minute, an antistatic hard coat layer was formed by irradiating with 120 W output power of ultraviolet light for 10 seconds from a point 20 cm away using a metal halide lamp. The resultant hard coat layer was 5 μm in thickness and 1.58 in refractive index.

### <Formation of Low Refractive Index Layer>

A low refractive index layer was formed in a similar way to that in <<Example 1>>. The resultant hard coat layer was 91 nm in thickness, 1.37 in refractive index and 125 nm in optical thickness.

In this way, an anti-reflection film having a transparent substrate, an antistatic hard coat layer and a low refractive index layer in order, and a polarizing plate having an antistatic hard coat layer and a low refractive index layer in order on a polarizing plate which includes a transparent substrate, a polarizing layer and another transparent substrate were manufactured.

The obtained anti-reflection films and polarizing plates received following measurement.

### <<Measurements of Anti-Reflection Film Characteristics>>

### <Measurement of Average Luminous Reflectance and Reflection Hue>

The opposite surface of the obtained anti-reflection film from the side on which the low refractive index layer was formed was painted black with a matte-black spray. Then, a measurement was performed by an automated spectral photometer (U-4000 made by Hitachi, Ltd.), and average luminous reflectance (Y %) and hue (a*, b*) of the surface on which the low refractive index layer was formed was obtained from the spectral reflectance at 5 degrees of incident angle under 2 degrees of field of view condition with a C light source. Photopic relative luminous efficiency was used as the relative luminosity.

### <Measurement of Spectral Reflectance>

The opposite surface of the obtained anti-reflection film from the side on which the low refractive index layer was formed was painted black with a matte-black spray. Then, the spectral reflectance of the surface on which the low refractive index layer was formed was measured by an automated spectral photometer (U-4000 made by Hitachi, Ltd.) at 5 degrees of incident angle under 2 degrees of field of view condition with a C light source.

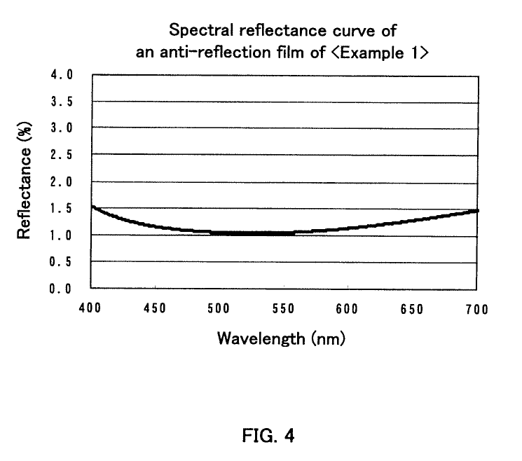

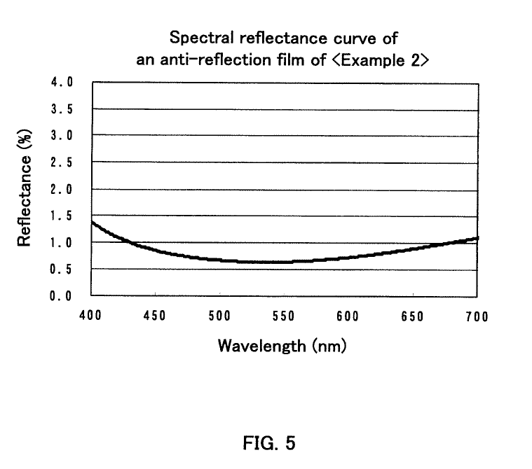

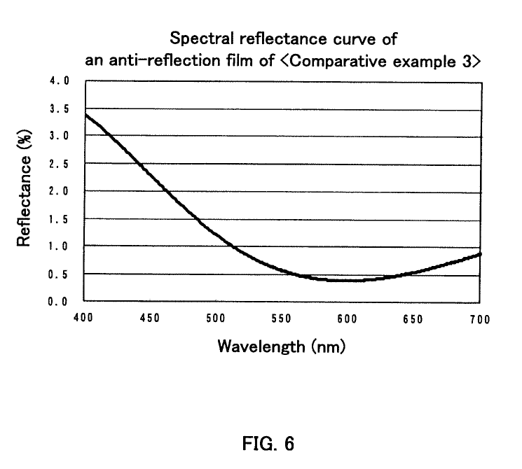

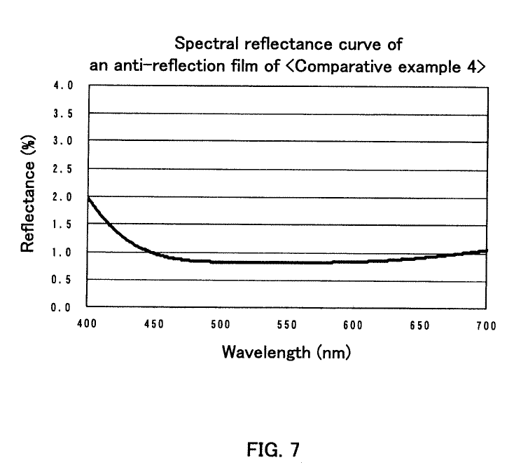

FIG. 4 shows the spectral reflectance curve of the anti-reflection film obtained in <<Example 1>>. FIG. 5 shows the spectral reflectance curve of the anti-reflection film obtained in <<Example 2>>. FIG. 6 shows the spectral reflectance curve of the anti-reflection film obtained in <<Comparative example 3>>. FIG. 7 shows the spectral reflectance curve of the anti-reflection film obtained in <<Comparative example 4>>.

### <Measurement of Haze (H), Parallel Light Transmittance>

The haze (H) and parallel light transmittance of the obtained anti-reflection film were measured by an image clarity meter (NDH-2000, made by Nippon Denshoku Industries Co., Ltd.).

### <Measurement of Absorption Loss in Average Luminous Transmittance and Absorption Loss in Transmittance at Various Wavelengths>

The spectral reflectance and spectral transmittance in a specular direction and rectilinear direction of the obtained anti-reflection film were measured by an automated spectral photometer (U-4000 made by Hitachi, Ltd.) using a C light source as the light source setting the incident angle and the output angle of the light source and the detector at 5 degrees from the vertical direction to the anti-reflection film surface under 2 degrees of field of view condition. Then, the absorption loss in average luminous transmittance (Q) and absorption loss in transmittance at certain wavelengths (Q₄₅₀: absorption loss in light transmittance at the wavelength of 450 nm, Q₅₅₀: absorption loss in light transmittance at the wavelength of 550 nm and Q₆₅₀: absorption loss in light transmittance at the wavelength of 650 nm) were calculated. At this point, the absorption loss in average luminous transmittance (Q) and absorption loss in transmittance at certain wavelengths (Q₄₅₀: absorption loss in light transmittance at the wavelength of 450 nm, Q₅₅₀: absorption loss in light transmittance at the wavelength of 550 nm and Q₆₅₀: absorption loss in light transmittance at the wavelength of 650 nm) were obtained according to the [Formula 1] and photopic relative luminous efficiency was used as the relative luminosity.

Q=100−H−T−R: ((Equation 1))

Q: Absorption loss in transmittance (%)

### H: Haze (%)

### T: Transmittance (%)

R: Reflectance on two (rear and front) surfaces (%)

### <Measurement of Surface Resistivity>

The measurement was performed by a high resistivity measurement meter (Hiresta MCP-HT260 made by DIA Instruments Co., Ltd.) conforming to JIS (Japanese Industrial Standards) K6911.

### <<Measurements of Polarizing Plate Characteristics>>

### <Measurement of Parallel Average Luminous Transmittance, Parallel Hue and Orthogonal Average Luminous Transmittance>

The obtained polarizing plate and a polarizing plate which had no hard coat layer and no anti-reflection layer were arranged with a tackiness layer in a way that the polarizing axes thereof were disposed parallel to each other. Then, the spectral transmittance in a rectilinear direction was measured by an automated spectral photometer (U-4000 made by Hitachi, Ltd.) using a C light source as the light source setting the incident angle and the output angle of the light source and the detector at 5 degrees from the vertical direction to the anti-reflection film surface under 2 degrees of field of view condition so that the orthogonal average luminous transmittance was obtained.

In the examples, the thickness of the hard coat layer was obtained by a stylus type thickness meter. In addition, the thickness of the antistatic layer and the low refractive index layer was measured by observing cross sections of the layers with a transmission electron microscope (TEM). Furthermore, the refractive index and the optical thickness of the hard coat layer, antistatic layer and the low refractive index layer were obtained by an optical simulation based on the measured spectral reflectance.

The measurement results are shown in Table 1A to Table 1C.

TABLE 1A

| | Anti-reflection film | | | | |
|---|---|---|---|---|---|
| | | | | | Difference |
| | | | | | between |
| | | | | Absorption | the max. |
| | | | | loss in | and min. of |
| | | | Parallel | average | absorption |
| | Average | | light | luminous | loss in |
| | luminous | | trans- | transmittance | transmittance |
| | reflectance | Haze | mittance | Q | Q |
| Example 1 | 1.1% | 0.1% | 94.9% | 1.3% | 0.8% |
| Example 2 | 0.7% | 0.1% | 94.5% | 1.3% | 0.7% |
| Example 3 | 1.0% | 0.1% | 94.2% | 2.0% | 1.5% |
| Example 4 | 1.4% | 0.3% | 94.5% | 1.3% | 0.8% |
| Example 5 | 0.5% | 0.4% | 95.8% | 2.5% | 1.7% |
| Comparative | — | — | — | — | — |
| example 1 | | | | | |
| Comparative | 1.1% | 0.1% | 96.1% | — | — |
| example 2 | | | | | |
| Comparative | 0.3% | 0.1% | 96.0% | 0.4% | 0.2% |
| example 3 | | | | | |
| Comparative | 0.8% | 0.1% | 96.2% | <0.1% | 0.1% |
| example 4 | | | | | |
| Comparative | 1.1% | 0.6% | 85.2% | 6.4% | 4.0% |
| example 5 | | | | | |

TABLE 1B

| | Anti-reflection film | | | | | |
|---|---|---|---|---|---|---|
| | Absorption loss | | | | | |
| | in transmittance | | | | | |
| | at wavelengths of | | | Reflection | | Surface |
| | 450, 550 and 650 nm | | | hue | | resistivity |
| | Q₄₅₀ | Q₅₅₀ | Q₆₅₀ | a* | b* | (Ω/□) |
| Example 1 | 1.0% | 1.3% | 1.6% | 1.96 | −1.30 | 2.8 × 10⁹ |
| Example 2 | 1.0% | 1.3% | 1.5% | 2.89 | −2.61 | 3.0 × 10⁹ |
| Example 3 | 1.4% | 2.2% | 2.7% | 2.40 | −2.30 | 8.0 × 10⁹ |
| Example 4 | 1.1% | 1.3% | 1.6% | 0.99 | −0.35 | 3.2 × 10⁹ |
| Example 5 | 1.6% | 2.4% | 3.1% | 2.89 | −1.33 | 9.0 × 10⁹ |
| Comparative | — | — | — | — | — | — |
| example 1 | | | | | | |
| Comparative | — | — | — | 2.72 | −1.80 | >1.0 × 10¹³ |
| example 2 | | | | | | |
| Comparative | 0.3% | 0.4% | 0.4% | 7.99 | −15.9 | 1.2 × 10¹⁰ |
| example 3 | | | | | | |
| Comparative | <0.1% | <0.1% | <0.1% | 1.96 | −2.61 | 6.0 × 10⁹ |
| example 4 | | | | | | |
| Comparative | 4.8% | 6.3% | 7.5% | 2.60 | −0.81 | 1.0 × 10¹⁰ |
| example 5 | | | | | | |

TABLE 1C

| | Polarizing plate | | | |
|---|---|---|---|---|
| | | | | Orthogonal average |
| | Parallel average | Parallel hue | | luminous |
| | luminous transmittance | a* | b* | transmittance |
| Example 1 | 39.2% | −2.10 | 2.90 | 0.05% |
| Example 2 | 39.3% | −1.70 | 4.90 | 0.05% |
| Example 3 | 38.9% | −1.90 | 2.30 | 0.04% |
| Example 4 | 39.4% | −2.30 | 3.10 | 0.05% |
| Example 5 | 39.1% | −2.10 | 2.90 | 0.06% |
| Comparative | 37.7% | −2.90 | 7.20 | 0.04% |
| example 1 | | | | |
| Comparative | 40.2% | −3.10 | 8.10 | 0.08% |
| example 2 | | | | |
| Comparative | 39.3% | −3.40 | 9.00 | 0.09% |
| example 3 | | | | |
| Comparative | 40.1% | −3.10 | 8.40 | 0.08% |
| example 4 | | | | |
| Comparative | 35.1% | −2.40 | 6.20 | 0.02% |
| example 5 | | | | |

In addition, the obtained films were evaluated as follows.

### <<Evaluation of Color Unevenness>>

The opposite surface of the obtained anti-reflection film from the side on which the low refractive index layer was formed was painted black with a matte-black spray. Then, the anti-reflection film was visually observed to evaluate if color unevenness occurred. The evaluation criteria were as follows.

Double circle: Color unevenness was not perceived under a dark condition and was hardly perceived even under a bright condition.
Circle: Color unevenness was not perceived under a dark condition and was perceivable but acceptable under a bright condition.
Triangle: Color unevenness was perceivable even under a dark condition.
Cross: Color unevenness was severely perceivable even under a dark condition.

### <<Evaluation of Contrast>>

The obtained anti-reflection film was pasted on a surface of a transmission type LCD (FTD-W2023ADSR, made by BUFFALO Inc.) with a tackiness layer in a way that the anti-reflection layer was arranged as the outermost (surface) layer. A black image and a white image were displayed on the resultant transmission type LCD. Luminance in a bright place (200 lux) and luminance in a dark place (0 lux) were measured by switching the indoor lighting between on and off, and then the contrast was obtained as a ratio of (luminance during a white image was displayed)/(luminance during a black image was displayed). The contrast was evaluated according to the following criteria, regarding the obtained anti-reflection film in <<Comparative example 2>> as the standard.

### <Contrast in a Bright Place>

Circle: Contrast in a bright place was improved by 10% or more relative to that in <<Comparative example 2>>.
Triangle: Contrast in a bright place had substantially no difference with that in <<Comparative example 2>> (The difference was less than ±10%).
Cross: Contrast in a bright place decreased by 10% or more relative to that in <<Comparative example 2>>.

### <Contrast in a Dark Place>

Circle: Contrast in a dark place improved by 10% or more relative to that in <<Comparative example 2>>.
Triangle: Contrast in a dark place had substantially no difference with that in <<Comparative example 2>> (The difference is less than ±10%).
Cross: Contrast in a dark place decreased by 10% or more relative to that in <<Comparative example 2>>.

TABLE 2

| | Color | Contrast evaluation | |
|---|---|---|---|
| | unevenness | In a bright | In a dark |
| | evaluation | place | place |
| Example 1 | ⊚ | ◯ | ◯ |
| Example 2 | ⊚ | ◯ | ◯ |
| Example 3 | ⊚ | ◯ | ◯ |
| Example 4 | ⊚ | ◯ | ◯ |
| Example 5 | ⊚ | ◯ | ◯ |
| Comparative example 1 | — | X | Δ |
| Comparative example 2 | ◯ | — | — |
| Comparative example 3 | X | Δ | Δ |
| Comparative example 4 | Δ | Δ | Δ |
| Comparative example 5 | X | X | X |

In <<Example 1>> to <<Example 5>>, anti-reflection films which not only have sufficient anti-reflection properties and sufficient antistatic properties but also inhibit color unevenness and color on reflection light, and which provides an anti-reflection film having an excellent contrast in a bright place and an excellent contrast in a dark place when the film is applied on a surface of a display device, especially a transmission type LCD device.

What is claimed is:

1. An anti-reflection film comprising:
a transparent substrate;
a hard coat layer;
an antistatic layer; and
a low refractive index layer, said hard coat layer, said antistatic layer and said low refractive index layer being formed on said transparent substrate, average luminous reflectance of said anti-reflection film on said low refractive index layer's surface being in the range of 0.5-1.5%, a difference between the maximum and the minimum in spectral reflectance of said anti-reflection film on said low refractive index layer's surface within a wavelength region in the range of 400-700 nm being in the range of 0.2-0.9%, an absorption loss in average luminous transmittance of said anti-reflection film being in the range of 0.5-3.0%, and a parallel light transmittance of said anti-reflection film being in the range of 94.0-96.5%.

2. The anti-reflection film according to claim 1, wherein a difference between the maximum of absorption loss in light transmittance of said anti-reflection film at wavelengths in the range of 400-700 nm and the minimum of absorption loss in light transmittance of said anti-reflection film at wavelengths in the visible light region is 4.0% or less.

3. The anti-reflection film according to claim 1, wherein a haze of said anti-reflection film is 0.5% or less.

4. The anti-reflection film according to claim 1, wherein a difference between the maximum of absorption loss in light transmittance of said anti-reflection film at wavelengths in the visible light region and the minimum of absorption loss in light transmittance of said anti-reflection film at wavelengths in the visible light region is in the range of 0.5-4.0%, and absorption losses in light transmittance of said anti-reflection film at wavelengths of 450 nm, 550 nm and 650 nm satisfies Q₄₅₀<Q₅₅₀<Q₆₅₀, wherein Q₄₅₀ is the absorption loss in light transmittance at a wavelength of 450 nm, Q₅₅₀ is the absorption loss in light transmittance at a wavelength of 550 nm, and Q₆₅₀ is the absorption loss in light transmittance at a wavelength of 650 nm.

5. The anti-reflection film according to claim 1, wherein said antistatic layer includes an electron conducting polymer and/or electron conducting inorganic particles.

6. The anti-reflection film according to claim 1, wherein said antistatic layer includes at least any one of antimony doped tin oxide, phosphor doped tin oxide, fluorine doped tin oxide, and indium oxide tin oxide.

7. The anti-reflection film according to claim 1, wherein surface resistivity of said anti-reflection film on a surface of said low refractive index layer is in the range of 1.0×10⁶Ω/□ to 1.0×10¹¹Ω/□.

8. The anti-reflection film according to claim 1, wherein reflection hue in the L*a*b* coordinate system on a surface of said low refractive index layer satisfies 0.00≦a*≦3.00 and −3.00≦b*≦3.00.

9. The anti-reflection film according to claim 1, wherein a difference in refractive index of said hard coat layer and said transparent substrate is 0.05 or less.

10. A polarizing plate comprising:
said anti-reflection film according to claim 1;
a polarizing layer; and
a second transparent substrate, wherein said transparent substrate of said anti-reflection film has a first surface and a second surface opposite the first surface, said low refractive index layer is disposed on the first surface, and said polarizing layer and said second transparent substrate are arranged on the second surface.

11. A transmission type LCD device comprising:
said polarizing plate according to claim 10;
a liquid crystal cell;
a second polarizing plate; and
a backlight unit.

12. The anti-reflection film according to claim 2, wherein a haze of said anti-reflection film is 0.5% or less.

13. The anti-reflection film according to claim 12, wherein a difference between the maximum of absorption loss in light transmittance of said anti-reflection film at wavelengths in the visible light region and the minimum of absorption loss in light transmittance of said anti-reflection film at wavelengths in the visible light region is in the range of 0.5-4.0%, and absorption losses in light transmittance of said anti-reflection film at wavelengths of 450 nm, 550 nm and 650 nm satisfies Q₄₅₀<Q₅₅₀<Q₆₅₀, wherein Q₄₅₀ is the absorption loss in light transmittance at a wavelength of 450 nm, Q₅₅₀ is the absorption loss in light transmittance at a wavelength of 550 nm, and Q₆₅₀ is the absorption loss in light transmittance at a wavelength of 650 nm.

14. The anti-reflection film according to claim 13, wherein said antistatic layer includes an electron conducting polymer and/or electron conducting inorganic particles.

15. The anti-reflection film according to claim 14, wherein said antistatic layer includes at least any one of antimony doped tin oxide, phosphor doped tin oxide, fluorine doped tin oxide and indium oxide tin oxide.

16. The anti-reflection film according to claim 15, wherein surface resistivity of said anti-reflection film on a surface of said low refractive index layer is in the range of 1.0×10⁶Ω/□ to 1.0×10¹¹Ω/□.

17. The anti-reflection film according to claim 16, wherein reflection hue in the L*a*b* coordinate system on a surface of said low refractive index layer satisfies 0.00≦a*≦3.00 and −3.00≦b*≦3.00.

18. The anti-reflection film according to claim 17, wherein a difference in refractive index of said hard coat layer and said transparent substrate is 0.05 or less.

19. A polarizing plate comprising:
said anti-reflection film according to claim 18;
a polarizing layer; and
a second transparent substrate, wherein said transparent substrate of said anti-reflection film has a first surface and a second surface opposite the first surface, said low refractive index layer is disposed on the first surface, and said polarizing layer and said second transparent substrate are arranged on the second surface.

20. A transmission type LCD device comprising:
said polarizing plate according to claim 19;
a liquid crystal cell;
a second polarizing plate; and
a backlight unit.
